(19) United States
(12) Patent Application Publication
(10) Pub. No.: US 2017/0369376 A1
(43) Pub. Date: Dec. 28, 2017

(54) PROCESS FOR COMPLETE CONVERSION OF MULTIPLE INDUSTRIAL WASTES TO SUSTAINABLE ALTERNATIVES AND USABLE PRODUCTS

(71) Applicant: HARISH KANDHARI, UDAIPUR, RAJASTHAN (IN)

(72) Inventor: HARISH KANDHARI, UDAIPUR, RAJASTHAN (IN)

(21) Appl. No.: 15/541,278

(22) PCT Filed: Nov. 16, 2015
(86) PCT No.: PCT/IN2015/000423

§ 371 Date: Jun. 30, 2017

(30) Foreign Application Priority Data
Dec. 30, 2014 (IN) 4020/DEL/2014

(51) Int. Cl. C04B 28/10; C04B 40/02; C04B 22/14; C04B 18/14; C04B 18/12; C22B 3/08; C04B 18/04

(52) U.S. Cl. CPC C04B 28/10; C22B 3/08; C04B 40/0263; C04B 18/0409; C04B 18/149; C04B 18/12; C04B 22/149

(57) ABSTRACT

The invention is directed towards a process for complete conversion of multiple industrial wastes to sustainable alternatives and usable products resulting in water in-soluble product alike chemical gypsum useful for cement manufacturing used in construction industry. The inventor has utilized industrial wastes from multiple industries together taking into consideration their chemical and physical properties without using any form of energy. The whole process is carried out at ambient temperature under open sky. In described two exemplary processes, the inventor has disclosed process comprising the steps of mechanically mixing metallurgical inert waste of aged dry Jarofix containing crystallized Gypsum with freshly generated Jarosite or dry/wet Red Mud followed by addition of adequate acidic concentration waste water, calcitic wastes, pozzolanic property enhancers & lime treatment. The multiple wastes mix crystallized chemical gypsum mass on drying is used as a whole without any leftover.

### FIELD OF THE INVENTION

The present invention is related to industrial waste management process. More specifically, it is a process of complete conversion of multiple industrial wastes to sustainable alternatives and usable products.

### BACKGROUND OF THE INVENTION

Large amounts of refuse and wastes are generated from various industries such as marble industry, metallurgy & chemical industry, mining and constructional activities. Most of these are not being utilized but are rather disposed off in the limited disposal sites available which would exhaust in the near future. This is a major point of concern throughout the world. Therefore effective waste management needs to be considered.

### Types of Wastes and Their Effects

The main inorganic wastes are dust, slag, sludge & residue from the metallurgy i.e ferrous & non-ferrous industry, sludge & dust from the chemical, paper, granite, marble cutting and glass industries, and coal ash from the electric supply works. In addition to construction rubbish, large amounts of waste sludge and surplus soil are discharged during the foundation & dredging works, mine & quarry dust/tailings and sieve rejects, and finally the civic wastes & treated sewer sludge.

Marble slurry is a waste generated during the cutting and polishing of the marble. The amount of the marble slurry generated is very substantial and in the range of 5-6 million tonnes per annum. The heaps of this marble slurry acquire large land areas and remain scattered all around, spoiling the aesthetic of the entire region and have affected the tourism and industrial potential of the states.

Also, during metallurgical ore extraction process, large quantity of slag & residue is generated which is hazardous in nature and its safe use disposal is being searched for them. For example metallic zinc extraction from zinc sulphide or sulphide ore generates huge quantity of Jarosite universally as wet solid residue. The Jarosite mainly contains iron, sulphur, zinc, calcium, lead, cadmium and aluminium. The quality and quantity of Jarosite makes the task of disposing it safely more complex. Jarosite causes major problem of water contamination and major source of polluting soil, vegetation and aquatic and hence its disposal is of major concern because of the stringent environmental protection regulations. Similarly during aluminium production Alumina is extracted from bauxite by the Bayer process. The waste slurry generated in this process is called red mud. The slurry has a high solid concentration of 30 to 60% & high ionic strength. Environmental concern relate to its very large quantity generated and its causticity. About 1.5 metric tonnes of bauxite residue is generated for each tonne of alumina produced. It is stored in huge tailing ponds and this poses a significant problem, since it not only occupies vast land areas, but it can also lead to environmental pollution Hence, there is a need for better management strategies-preferably utilization of the Red Mud. However, currently there are not many large-volume applications of this bauxite residue besides minor raw material use in cement and ceramic production or use as an adsorbent.

Due to various problems linked to waste disposal, a need is felt that all kinds of waste must be utilized effectively and therefore waste management and use disposal must be considered seriously.

### Economic Advantage of Waste Utilization:

An effective waste management system must exhibit most of the following features:
It should be able to reduce the total construction costs by replacing natural constructional products fully or partially.
It should be able to provide alternative solutions which are easy to handle and do not easily deteriorate when stored or undergo change in environment.
It should be able to use wastes as an “as is-product” without much additional cost incurred for treatment or processing for property modification of waste.
   In view of the above, economic benefits gained from wastes utilization are obvious since the cost of wastes appears to be either less than that of natural material or much less than the cost to produce a new natural constructional material such as cement or concrete.

### Environmental Advantage of Waste Utilization:

Environmental gain can be attributed to the conservation of natural resources and energy and to mitigation of waste exposed in the environment.

### Currently Used Waste Management Techniques:

### 1. Reusing Unearthed Material

Many waste materials might be toxic and hazardous substances and require treatment for safe disposal. One such treatment can be in the form of geotechnical waste utilization. Geotechnical engineering is a field of engineering that is concerned with reusing wasted earth materials such as unearthed material from earthquakes, landslides and debris from mining for construction.

(Ref:http://www.ehow.com/info_8760512_geotechnical-uses-waste-materials.html)

This type of waste management can serve not only to prevent the negative environmental impact but also to preserve and protect nature through their combined conversion into mass consumed road and building construction materials.

Utilization of wastes as construction or geotechnical material has been strongly recommended and many attempts of geotechnical applications have been undertaken. Various kinds of ground improvement and soil stabilization techniques have been widely used to modify the engineering properties of waste for the geotechnical utilization as reported by Kamon and Katsumi (1994a).

### 2. Upgrading Industrial Wastes to Alternative Raw Materials

In recent years, several studies have confirmed the potential of civil construction as a suitable recipient of various types of treated wastes which are now considered secondary raw materials. Replacing natural raw materials with wastes may offer an opportunity to mitigate today's waste management problems. Since a lot of natural raw material is required in the production of cement, concrete and mortars in construction industry, converting wastes into a form suitable as “building constructional material” may prove to be a cheaper and renewable alternative. Therefore upgrading industrial wastes to alternative raw materials is both technically and economically advantageous for a wide range of applications.

### 3. Bulk Utilization of Waste Materials

This can be effectively done in construction industry without any compromise on quality/performance. There are certain industrial by-products that can be used as an alternative for conventional cement utilizing the cementitious properties of public & industrial by products such as:

i) Fly ash/dust ii) Granulated Blast Furnace Slag iii) Steel Slag iv) Red Mud v) Copper Slag vi) Lead-Zinc Slag vii) Jarosite/Jarofix viii) Phosphorus Furnace Slag ix) Chalks/Gypsum/Slurry/Salts/Dust x) Lime, Paper, Sugar, Chromium, Soda Ash Sludges xi) Marble &Granite Cutting Sludge and Rejects xii) Quarry Rejects and Dust, Mine Rejects/Tailings/Overburden xiii) Civic Wastes & Sludges

It has been established that fly ash/slag can replace cement partially. Similar results are obtained using different wastes effectively.

For efficient utilization of wastes, the properties and generating conditions of various wastes must be taken into consideration. Properties include whether the waste material is inorganic or organic, whether it contains heavy metals and so on. Generating conditions refer to when, where and how many waste materials are generated.

### Techniques Used for the Treatment of Hazardous and Toxic Substances

a) Cementitious grout stabilization/solidification: It is one of the most widely used techniques for the treatment and ultimate disposal of hazardous waste and low-level radioactive waste. Cementitious materials are the predominant materials of choice because of their low associated processing costs, compatibility with a wide variety of disposal methods and ability to meet stringent processing and performance requirements.

Stabilization/Solidification is the Best Demonstrated Available Technology (BDAT) for most of the Inorganic Species (RCRA metals).

Vitrification is “specified technology” BDAT for high-level radioactive waste containing arsenic, but otherwise stabilization/solidification is usually the best technique and has proven effective without the use of special additives in most cases.

Stabilizing Chromium (VI): Chromate is not directly stabilized by pH control which is the main technique for cement stabilization of metals. Chromates must be reduced to the less soluble chromium (III) valence state, prior to being stabilized. This can be accomplished in grouts using blast-furnace slag and/or special additives.

Stabilizing Mercury: It may seem to be more problematic but amalgamation of the element and precipitation of the ion as a sulphide has been done extensively. Grout stabilization of both elemental mercury and the soluble compounds has been demonstrated at the bench level using special additives. At the same time, Mercury currently cannot be vitrified and poses a volatility problem even at the low temperatures of thermoplastic encapsulation.

### Problem in Existing S/S Methods of Waste Management and Solutions Thereby Invented:

1. It is common to use fly ash in admixture with various products such as Portland cement and furnace slag to solidify the acidic hazardous toxic wastes like Jarosite. However the undesirable large amount of fly ash is added which increases the final volume considerably and of late it has become a saleable commodity.

Although it can be minimized by adding the minimal amount of additive but then strength and physical stability of the final waste form is compromised.

2. One more disadvantage of existing process of industrial waste management is that there is no method available which can utilize industrial wastes of various industries together to produce a utilizable product. Each industrial waste is being treated and managed separately without thinking of a process which could make use of different chemical properties of different wastes that could result in a cost effective product suitable for application in another industry.

3. Yet another limitation of existing method of industrial waste management is the inability of existing processes to adequately solidify liquid or sludge-type waste towards its immobilization. On research it is detected that major stabilization is complete within few curing hours of compatible wastes mixing.

Solidification and hardening happens on long landfill duration after maximum evaporation. However for use of S/S treated mass thereafter, the hardened mass after solidification has to be crushed or broken that involves manual or mechanical hammering. To overcome this additional breaking process of large volumes, the solidification process needs to be overlooked.

The full stabilizing and gypsum crystallization process for the mixed mass curing is accomplished through open sky drying process for 24 to 48 hours, however the solidifications is prevented through economical overturning or agitating the mass by tractor tilling.

4. One more limitation of existing processes and methods is the non-effectiveness in terms of strength of final product as most of the available processes have not taken care of physical or chemical properties of several pozzolanic constituents present in different mixed wastes.

### PRIOR ART AND ITS DRAWBACKS

Various researchers have been working to solve the problem of waste management as cited above. The approaches used are discussed in the patents below.

| S. | Patent | | Comparison |
|---|---|---|---|
| no. | application no. | Summary of invention | with present invention |
| 1. | US 2987411 A | Discloses a process for | The present invention discloses |
| | | making a light-weight | method of selecting wastes |
| | | aggregate wherein fly-ash | based on their chemical |
| | | is initially mixed with a | properties and then |
| | | material such as clay, shale | mechanically mixing different |
| | | and mixtures thereof. The | types of wastes, followed by |
| | | resulting mixture is then | neutralizing the pasty mass to a |
| | | fired in a substantially | neutral pH through addition of |
| | | non-oxidizing atmosphere | another calcite waste. One such |
| | | at temperature of about | example of the present |
| | | 1500° to 2400° F. | invention is producing |
| | | | crystallized chemical gypsum |
| | | | mass possessing pozzolanic |
| | | | properties by mechanically |
| | | | mixing metallurgical waste in |
| | | | the form of aged dry Jarofix |
| | | | containing low purity |
| | | | crystallized Gypsum with |
| | | | freshly generated Jarosite |
| | | | followed by addition of other |
| | | | wastes. |
| | | | There is no requirement of |
| | | | firing the mixture at high |
| | | | temperature. Therefore the |
| | | | present invention is cost |
| | | | effective and environment |
| | | | friendly. |
| 2. | US 20090288582 A1 | Discloses a method for | In comparison, the present |
| | | making a low embodied | invention mixes various |
| | | energy cementitious | industrial wastes and as an |
| | | mixture by blending a | example, discloses a final |
| | | variety of post-consumer | product which can replace |
| | | wastes, post-industrial | mineral gypsum possessing |
| | | wastes, as well as | pozzolanic properties used for |
| | | renewable, organic and | cement manufacturing, and is |
| | | recyclable materials with | not concrete. |
| | | Portland cement or a | |
| | | material having similar | |
| | | cementitious properties. | |
| | | The final product is | |
| | | concrete. | |
| 3. | US 5084102 A | Considers another post- | In comparison, the present |
| | | industrial waste-blast | invention mixes various |
| | | furnace slag, as an | industrial wastes and as an |
| | | ingredient for a ready-to- | example, utilizes acidic Jarosite |
| | | use dry powder that when | or aged Jarofix or mix of both, |
| | | combined with water can | or the Red Mud generated in |
| | | be used in concrete | large quantities by metal |
| | | constructions, products or | industries (non-ferrous) and |
| | | parts. | multiple other wastes to |
| | | | produce a final product in the |
| | | | form of crystallized chemical |
| | | | gypsum mass possessing |
| | | | pozzolanic properties. |
| 4. | US 4124405 A | The present invention | The present invention discloses |
| | | discloses method of | a method of mixing various |
| | | converting water-soluble | industrial wastes and as an |
| | | pollutants present in wastes | example, utilizes acidic Jarosite |
| | | and residues into water- | or aged Jarofix or mix of both |
| | | insoluble solid masses by | or the use of Red Mud for |
| | | treatment with a particulate | producing crystallized chemical |
| | | metallurgical slag under | gypsum mass possessing |
| | | alkaline conditions, in the | pozzolanic properties. |
| | | presence of hydration- | |
| | | promoting agents for the | |
| | | slag. | |
| 5. | WO 2013084173 A1 | The present invention | The present invention discloses |
| | | discloses an integrated | an integrated method and system |
| | | method and system for | for recycling various industrial |
| | | recycling stone wastes, | wastes to produce sustainable |
| | | preferably of the alumina | alternatives and as an example, |
| | | silicate-type into glass. | acidic Jarosite or aged Jarofix |
| | | | or mix of both or the Red Mud |
| | | | generated in metal industries |
| | | | (non-ferrous) along with other |
| | | | wastes is explored. Here, |
| | | | landfill disposal of acidic |
| | | | Jarosite or aged Jarofix and |
| | | | various other wastes is |
| | | | eliminated or at least |
| | | | minimized. |
| 6. | US 20030205175A1 | The invention discloses the | The present invention discloses |
| | | method for the production | a method of mixing various |
| | | of cement clinker which | industrial wastes to produce |
| | | uses fragmented | sustainable alternatives and as |
| | | metallurgical slag and | an example, utilizes acidic |
| | | limestone stone/feedstock. | Jarosite or aged Jarofix or mix |
| | | Thereby utilising waste | of both or utilizes highly |
| | | metallurgical slag. | alkaline Red Mud for producing |
| | | | crystallized chemical gypsum |
| | | | mass possessing pozzolanic |
| | | | properties. The complete |
| | | | process is carried out at ambient |
| | | | temperature without consuming |
| | | | additional energy and without |
| | | | any leftover waste. |
| 7. | CN 103539368 A | The invention discloses a | The present invention discloses |
| | | method for producing | a method of mixing various |
| | | cement by utilizing waste | industrial wastes to produce |
| | | stone powder replacing | sustainable alternatives and as |
| | | partly or fully a limestone | an example, for producing |
| | | raw material and waste | chemical gypsum possessing |
| | | granite replacing clay. | pozzolanic properties, the |
| | | Thus, utilization of marble | inventor has utilized multiple |
| | | dust through calcining-heat | industrial wastes and that too at |
| | | energy use is disclosed. | ambient temperature. Thus, |
| | | | utilization of wastes takes place |
| | | | without consuming any |
| | | | additional energy by way of |
| | | | heating. |
| 8 | KR101394549 (B1) | Disclosed are artificial | The present invention discloses |
| | | lightweight aggregates | a process for producing |
| | | with improved chemical | crystallized chemical gypsum |
| | | resistance and durability | mass possessing pozzolanic |
| | | by using sewage sludge | properties by the method of |
| | | and an inorganic | mechanical mixing |
| | | solidification agent and a | immobilized Jarosite waste |
| | | method for producing the | generated by zinc industry into |
| | | same. The aggregate is | gypsum bearing non-hazardous, |
| | | produced by mixing 100 | chemically inert and physically |
| | | parts by weight of sewage | stable mass called Jarofix as |
| | | sludge and 50 parts by | gypsum seeding agent with said |
| | | weight of clay, (moisture | metallurgical Jarosite waste in |
| | | content of 60-90%), to | proportion 0.25:1 and then |
| | | form a main material, | adding effluent acidic water, |
| | | mixing 100 parts by weight | spent H2SO4 and sodium |
| | | of the main material with | sulphate waste catalyst from |
| | | 30-50 parts by weight of | zinc industry. Further, |
| | | an inorganic solidification | imparting of pozzolanic |
| | | agent, where blast furnace | properties is done by adding |
| | | slag, paper slag, lime and | stone crushing dust providing |
| | | gypsum are mixed with | silica. Thus, utilization of |
| | | each other, to form a | marble dust & metallurgical |
| | | mixture and heating and | waste combined with other |
| | | plasticizing the moulded | multiple wastes takes place |
| | | article formed by | without consuming any |
| | | compression moulding for | additional energy by way of |
| | | 3-5 min at 1,000-1,200 C. | heating same as in case of |
| | | | compared inventions. |
| 9 | KR20040001079 (A) | This discloses a method for | The present invention discloses |
| | | making calcium sulfo | a process involves producing |
| | | aluminate clinker and | crystallized chemical gypsum |
| | | cement having high | mass possessing pozzolanic |
| | | strength, fast setting | properties by the method of |
| | | property and expansion | mechanical mixing in Transit |
| | | property by using waste | concrete mixer drum truck |
| | | by-products. | above ground of Jarofix, which |
| | | | is immobilized Jarosite waste |
| | | | generated by zinc industry into |
| | | | non-hazardous, chemically inert |
| | | | and physically stable mass |
| | | | called Jarofix, with other |
| | | | suitable wastes. Similar process |
| | | | can be applied for utilization of |
| | | | alkaline Red Mud. |
| 10 | RU2494057 (C1) | The invention discloses a | The present invention discloses |
| | | process for making | a process involves producing |
| | | gypsum binder based on | crystallized chemical gypsum |
| | | sludge wastes, which | mass possessing pozzolanic |
| | | involves mechanical | properties by the method of |
| | | activation of the sludge | mechanical mixing in drum |
| | | wastes in a ball mill and | trucks of Jarofix, which is |
| | | heat treatment thereof, is | immobilized Jarosite waste |
| | | characterised by that the | generated by zinc industry into |
| | | sludge wastes used are | non-hazardous, chemically inert |
| | | sludge wastes from | and physically stable mass |
| | | processing catalysts for | called Jarofix, with other |
| | | producing nonferrous | wastes, without consuming any |
| | | metals, having the | additional energy by way of |
| | | following chemical | heating as in case of compared |
| | | composition, %: loss on | invention. The wet mixed mass |
| | | ignition-21.12, SiO-0.05, | sun dried under open sky during |
| | | FeO-0.06, CaO-32.0, | the day & tarpaulin covered in |
| | | MgO-0.10, SO-6.8; the | the night for optimum curing |
| | | sludge wastes are dried | and gypsum crystallization. |
| | | before mechanical | Similar process is applied for |
| | | activation and heat | gypsum crystallization through |
| | | treatment is carried out at | use of Red Mud mechanically |
| | | atmospheric pressure. | mixed with other compatible |
| | | | wastes in concrete drum trucks |
| | | | and open sky drying. |

Therefore it is obvious that methods that have been used in the past for the disposal of wastes have used the process of solidifying the waste by mixing it with various pozzolanic materials and polymeric substances. Pozzolanic properties inbuilt through available constituents in wastes itself is the novelty devised herein. The past patents have emphasized on mixing of wastes possessing cementitious/pozzolanic properties especially fly ash/slags from iron industry either for cement clinker production or addition in primary concrete made of Portland cement to make it cost effective. A few of these have also added stone powder for clinker production which is hot melt process that includes use of energy. Turning non-pozzolanic wastes into usable pozzolanic input through compatible wastes mix is the new inventive step.

There has been no consideration towards reduction of volume which increases considerably by treating wastes and making them usable without compromising on strength and physical stability. Further no method is available which can utilize industrial wastes of various industries together to produce a utilizable novel pozzolanic product from wastes replacing priced sustainable alternatives like fly ash and slags. On the contrary, in the present invention, mixing the excessive wet Jarosite with dry Jarofix or wet Red Mud and other wastes, not only the high moisture problem is taken care of but the entire mixed volume becomes gainfully utilisable with low desirable moisture content.

Thus, to the best none of the prior art patents or publications can be said to anticipate present invention.

### OBJECTS OF THE PRESENT INVENTION

1. It is an object of the present invention to disclose a process for complete conversion of multiple industrial wastes to sustainable alternatives e.g. into chemical gypsum mass possessing pozzolanic properties, in a way such that the wastes, whether acidic, alkaline or neutral from various industries, are used as an “as is-product” without any heat treatment or processing of any kind for making the end product suitable for use in another industry.

2. Yet another object of the present invention is to disclose a process of complete conversion of multiple industrial wastes to sustainable alternatives e.g. chemical gypsum used in cement manufacturing, which can utilize industrial wastes of various industries together to produce a fully usable product without any left over.

3. One more object of the present invention is to provide a process of complete conversion of multiple industrial wastes to sustainable alternatives, said process reducing the solubility of heavy metals in an inexpensive, safe, and simple manner.

4. Yet another object of the present invention is to provide process of complete conversion of multiple industrial wastes to sustainable alternatives e.g gypsum for cement manufacturing, such that the final product of said process, is non degradable, non-pollutant, eco-friendly and economically transportable.

### SUMMARY OF THE INVENTION

The invention is directed towards a process of converting industrial wastes of various industries together to produce sustainable alternative e.g. automatic crystallized chemical gypsum in pozzolanic mixed mass used in cement manufacturing. The process results in an environmentally safe, water in-soluble, gainfully usable product alike mineral gypsum. As an example, a process is disclosed for producing crystallized chemical gypsum mass possessing pozzolanic properties by utilizing aged dry Jarofix containing crystallized Gypsum with freshly generated Jarosite and adding waste effluent acidic water generated after gas cleaning plant in zinc industry, foreign matters duly filtered, followed by addition of preferably spent H₂SO₄ generated as acidic waste from different industries. For catalysing optimum gypsum crystallization, addition of sodium sulphate waste viz. MEE salt generated in zinc industry, carrying constituents of sodium, sulphate and chlorine is used. For enhancing pozzolanic properties, stone crushing dust known as quarry dust waste rich in silica is added.

In various other embodiments, the inventor has utilized industrial wastes like Red Mud & Tailings/Overburden from multiple industries together taking into consideration their chemical and physical properties. No use of any form of heat energy is required to prepare the final product as the process itself activates & catalyses the mix reaction carried out at ambient temperature without the need of heating or melting. Moreover there is no by product or waste generation. Mechanical mixing in transit or stationary concrete mixer and sun drying eliminate the need of an industrial set up. Therefore a process for complete conversion of multiple industrial wastes above ground level and free from leach pollutants to produce sustainable alternatives is disclosed.

### DETAILED DESCRIPTION OF THE INVENTION

In the past, various attempts to solidify waste were and are being carried out using Portland cement but the resulting product is very permeable, porous, subject to leaching and deficient in mechanical strength. For promoting the interaction of various compounds, use of the other pozzolanic materials such as fly ash having better physical properties, was also tried but is rendered ineffective due to un-desirable quick setting of such materials even before the waste could be uniformly dispersed. Adding a small quantity of polymer cannot produce requisite strength in the resulting product and to achieve the needed strength, large quantities of the polymer are required. This again causes the problem of large volume handling & economy of scale.

Furthermore, the use of polymeric compounds to promote the Stabilization/Solidification (S/S) process effect is also undesirable because many polymeric compounds themselves are complex and hazardous making the resulting product toxic. In such case, chemical attack such as sulphate attack is catalyzed. Also, the resultant product degenerates over time. Thus, such disposal is undesirable.

The inventor studied various processes disclosed by scientists in last 40 years within US EPA regulatory framework on S/S process for mixed wastes.

Immobilizing of Jarosite waste generated by zinc industry is presently being done by said S/S method through treatment with admixture of lime and cement powder that exhibits low leachability & low compressive strength. The hazardous character of Jarosite waste is transformed into non-hazardous, chemically inert, physically stable mass called Jarofix that eliminates all short and long term environmental risks during and after its landfill.

During this process, cement partially decomposes around ⅓^{rd} of Na-jarosite to evolve Ca-Jarosite, Ferric hydroxide and Sodium sulphate that further reacts with lime to crystallize gypsum, increasing pH and retaining minor amount of Ca—Al—Fe-silicate-sulphate-hydrate phases with traces of calcite.

Acid water in wet jarosite is neutralized using lime thereby precipitating heavy metals that get immobilised due to formation of respective insoluble carbonates and hydroxides.

Cured and aged Jarofix after years of aging & continued evaporation becomes moisture free & dry and can exhibit the same micro texture as those of freshly cured Jarosite. However the stored Jarofix gets depleted in Ca-Jarosite and cement phases and is enriched in gypsum and calcite that reflect high alkaline environment of Jarofix products. The said aged products also have increased amounts of Ca—Al—Fe-silicate-sulphate-hydrate phases possessing elevated Zn—Mg contents. This implies a further immobilization of residual water soluble Zn and Mg during storage making it entirely metal free.

(Ref: Lead-Zinc 2000 edited by John E Dutrizac, J. Gonzalez, J Henke, S. James, A Siegmund.)

The inventor in consideration of above finding, has invented a unique and novel process of converting industrial waste to sustainable alternatives.

The present invention discloses method of selecting wastes based on their chemical and physical properties and then mechanically mixing different types of wastes, followed by neutralizing the pasty mass to a neutral pH through addition of another calcite waste &/or small lime quantity for dolomite wastes, providing leeway for material in consistencies of different wastes mixed.

One such example of the present invention is producing crystallized chemical gypsum mass possessing pozzolanic properties by utilizing aged dry Jarofix containing crystallized Gypsum with freshly generated Jarosite.

Another example of the present invention is producing crystallized chemical gypsum mass possessing pozzolanic properties by utilizing aged dry or wet alkaline Red Mud.

The inventor after a careful thought, came to a conclusion that if aged Jarofix exhibits the same micro-texture as that of Jarosite and contains crystallized gypsum within its structure, it can also be used as a gypsum seeding agent when partially mixed with freshly generated Jarosite to optimise the gypsum percentage in total mix mass of wastes.

In carrying out the above Jarosite/Jarofix mix gypsum crystallization experiment, addition of around 10% low concentration acidic water is required. Use of acidic water from zinc secondary leaching process available in wet Jarosite could not solve the problem as it contained low concentration about 10 to 15 gms/ltr. Of H₂SO₄. The wetting of dry Jarofix and other mixed wastes mass required further addition of fresh water which is a scarce and costly resource.

Zinc industry treats effluent acidic water after gas cleaning by recycling through lime treatment which is a not a cost effective way. This acidic effluent waste water is added in place of fresh water but after increasing its acidic concentration to around 10% H₂SO₄ conc. To do so, the inventor utilized spent Sulphuric acid by way of adding one more waste to effluent acidic waste water after filtering the suspended foreign matters and venting toxic gases if any.

To optimise the gypsum crystallization in above described process a catalysing agent such as Sodium sulphate was essential. Since the cost of fresh sodium sulphate is prohibitive, using sodium sulphate waste was the alternative.

Zinc industry generates waste MEE salt, landfilled presently, which carries constituents of Sodium, Sulphate and Chlorine was used as catalyst after several experiments to overcome chlorine effect. Thus one more waste of Zinc industry got included in this novel sustainable initiative of multiple wastes conversion to usable product.

The use of Jarofix above was in low quantity whereas its landfill over last many years was in millions of tons world over. Exclusive Use of Jarofix towards required level of gypsum crystallization was therefore the necessity, however its low compressive strength makes it non-usable in cement manufacturing. Therefore additives that enhanced the physical properties of exclusive Jarofix wastes mixed mass was essential.

Towards imparting pozzolanic properties to the final chemical gypsum mass using multiple wastes, it could be achieved taking advantage of Ca—Al—Fe phases present both in Jarosite and Jarofix but Silica was missing in this composition. The inventor taking note of acidic chemical reaction in gypsum crystallization, thought of replenishing silica in the mixed mass by putting to use one more silica based waste. One such waste is from stone crushing named quarry dust possessing high percentage of silica and lies in abundance as land fill near stone crushers.

Thus the inventor made possible crystallization of gypsum of required purity level usable in cement manufacturing out of Jarosite or Jarofix individually as also through a method of mixing of both Jarosite and Jarofix by use of number of different non-usable wastes that till date were being landfilled.

While the mineral gypsum beyond gypsum percentage carried impurities, the chemical gypsum made out of Jarosite/Jarofix was made to possess pozzolanic properties using the present invention, high requisite purity level imparted, is non-hazardous and is useful in cement manufacturing.

Similarly the inventor made possible crystallization of gypsum of adequate purity level usable in cement manufacturing out of alkaline Red Mud through a method of mixing of Red Mud with use of number of different non-usable tailings/overburden wastes that till date were being land stored.

No use of any form of energy is required to prepare the final product as the process takes care of chemical and physical properties of wastes and is carried out at ambient temperature without the need of heating or melting. There is no need of firing the mixture at high temperature. In this process of complete conversion of multiple industrial wastes to sustainable alternative usable products if the mixed mass is dried by heating using any means, the process may result in a low purity gypsum product but the other advantages remain the same. Additional advantage invented is that there is no residual waste generation or leftover of any form.

Therefore complete conversion of multiple industrial wastes to sustainable alternatives is disclosed.

The process results in an environmentally safe, water in-soluble, immobilized usable crystallized gypsum product possessing pozzolanic properties replacing additional fly ash mixing in cement over the quantities normally mixed.

One of the preferred embodiments of the said process of the present invention comprise the steps of:

1. Mechanically mixing metallurgical waste in the form of aged dry Jarofix containing crystallized Gypsum with freshly generated Jarosite in a proportion of ¼ to ½:1 by weight.

2. Addition of toxic gases free waste effluent acidic water generated in zinc industry in a ratio of 0 to 30% by weight.

3. Addition of spent H₂SO₄ generated as acidic waste from different industries after filtering the suspended foreign matters in a ratio of 0 to 15% by weight.

4. Addition of sodium sulphate MEE salt waste generated in zinc industry, carrying constituents of sodium, sulphate and chlorine in a ratio of 0 to 15% by weight.

5. Addition of quarry dust waste in a ratio of 0 to 25% by weight.

The final product after Lime treatment is crystallized chemical gypsum mass possessing pozzolanic properties.

As is obvious from the above, automatic gypsum crystallization is carried out by mixing of the wastes, catalysing agents and acidic water additives etc. of a fore mentioned steps carried out in a rotary drum mixer operating on or above ground continuously or intermittently.

Similar process for acid treated Red Mud mixed with other wastes provides chemical gypsum crystallization possessing pozzolanic properties.

Therefore a value-added disposal of wastes is achieved by putting to use the water-insoluble non-hazardous cured mass as disclosed above suitable for use as chemical Gypsum for manufacturing cement used in road, building and construction industry.

### Novelty:

The novelty of the present invention lies in developing a process of complete conversion of industrial wastes to sustainable alternative e.g chemical gypsum. No use of any form of energy or industrial activity is required to prepare the final product as the process takes care of chemical and physical properties of the compatible wastes and utilizes them “as is available product” irrespective of any specific climatic or geographical requirement for making the end product. The process is carried out at ambient temperature without the need of heating or melting to make it suitable for use in cement industry as gypsum during cement grinding.

None of the patents or articles, to the best of the knowledge of the inventor, have disclosed this novel approach.

### Inventive Step:

The inventive step of present invention lies in analyzing the chemical and physical properties of wastes of multiple industries and then developing a suitable activation & catalyzing method to treat compatible wastes together without use of energy in heating or melting, simultaneously providing solution to the excessive moisture present through mix of solid dry wastes and conservation of waste acidic effluent water, developing effective way of reducing the solubility of heavy metals in an inexpensive, safe, and simple manner. The resulting product made out of inert and dead mountains of Jarofix and marble dust or Red Mud and Tailings meets strength and stability tests and found to be non-degradable, easily transportable & used as chemical Gypsum for manufacturing cement used in constructing roads and buildings.

Therefore to develop a highly economical process, of mechanical mixing Leach free suitable acidic/alkaline wastes of multiple industries on or above ground eliminating contamination risk for any ground water or soil, optimising maximum gypsum crystallization the inventor has put in valuable inventive step unknown or invented in prior arts.

In the preceding detailed description, the invention is described with reference to two exemplary embodiments thereof. Various modifications and changes may be made thereto without departing from the broader spirit and scope of the invention as set forth in the description. The specification is accordingly, to be regarded in an illustrative rather than a restrictive sense. Thus without analysis, the foregoing will fully reveal the gist of the present invention that others can, by applying current knowledge, readily adapt it for various applications without omitting features that from the standpoint of prior art, fairly constitute essential characteristics of the generic or specific aspects of this invention

1. A process of complete conversion of multiple industrial wastes to sustainable alternative usable products wherein the same comprises the steps of:
(a) Mechanically mixing various industrial solid dry & wet wastes including effluent/spent acidic water and excessive Jarosite or Red Mud moisture, based on their compatible physical and chemical properties, drying under open sky—rain & dew protected through Tarpulin covering;
(b) Activating the dead and inert wastes like marble dust & Jarofix, cement kiln dust or any other such suitable wastes, towards seeding effect or for their full reuse;
(c) Catalysing the reaction through addition of another landfilled non-usable waste;
(d) Mixing compatible wastes towards producing pozzolanic properties material;

2. A process of complete conversion of multiple industrial wastes to sustainable alternative usable products wherein the same comprises the steps of:
Mechanically mixing metallurgical waste in the form of aged dry Jarofix before or after lime treatment, containing crystallized Gypsum with freshly generated Jarosite in a proportion of 0.25 to 0.5:1 by weight or by full use of either Jarofix or Jarosite, or use of Red Mud alone;
Addition of fresh or preferably spent H₂SO₄ generated as acidic waste in chemical industries duly filtered in a ratio of 0 to 30% by weight.
Addition of fresh water or preferably effluent acidic waste water generated internally in different industry after filtering of suspended particles or foreign matters, free of toxic gases in the ratio of 0 to 30% by weight.
Addition of marble cutting dust or cement kiln dust & limestone sieve cutting tailing in ratio of 0 to 50% by weight;
Addition of MEE salt waste generated in zinc industry, carrying constituents of sodium, sulphate and chlorine in a ratio of 0 to 15% by weight;
Addition of quarry dust waste in a ratio of 0 to 25% by weight;
Addition of lime slurry in a ratio of 0 to 15% by weight.

3. A process of complete conversion of multiple industrial wastes to sustainable alternative usable products as claimed in claim 1 wherein mixing of the acidic and alkaline wastes and other additives is carried out in a stationary or transit concrete rotary drum mixer operating continuously or intermittently, the mixed mass thereafter allowed to dry/cure for 24 to 48 hours under open sky, occasionally agitating the mass to restrict hardening.

4. A process of complete conversion of multiple industrial wastes to sustainable alternative usable products as claimed in claim 1 wherein mixing of the acidic and alkaline wastes and other additives is carried out in a stationary mixer or pug mill, operating continuously or intermittently the mixed mass dried thereafter by heating using any means, resulting in a low purity gypsum product.

5. A process of complete conversion of multiple industrial wastes to sustainable alternative products as claimed in claim 1 wherein the resulting product is water insoluble, non-pollutant, non-hazardous, fully usable possessing pozzolanic properties.

6. A process of complete conversion of multiple industrial wastes like Jarosite, Jarofix or Red Mud to sustainable alternative usable products like chemical gypsum of low purity used in cement manufacturing as claimed in claim 4 wherein the resulting product may not become completely water-insoluble, non-pollutant, non-hazardous or possess pozzolanic properties.

7. A process of complete conversion of multiple industrial wastes to sustainable alternative products as claimed in claim 1 wherein the industrial wastes are completely converted into usable sustainable alternative and no residual waste is left.

8. A process of complete conversion of multiple industrial wastes to sustainable alternative usable products as claimed in claim 1 wherein the resulting product is water-insoluble, non-pollutant, non-hazardous chemical gypsum fully usable possessing pozzolanic properties substantially as herein described and illustrated with reference to text descriptions made therewith.
